(19) United States
(12) Patent Application Publication
(10) Pub. No.: US 2012/0074865 A1
(43) Pub. Date: Mar. 29, 2012

(54) LIGHT EMITTING DIODE DRIVING DEVICE

(75) Inventors: Chung-Shu LEE, Taipei Hsien (TW); Chien-An Chen, Taipei Hsien (TW); Jhe-Yu Lin, Taipei Hsien (TW)

(73) Assignee: Chicony Power Technology Co., Ltd.

(21) Appl. No.: 12/890,680

(22) Filed: Sep. 26, 2010

(51) Int. Cl. H05B 37/02

(52) U.S. Cl. 315/291

(57) ABSTRACT

A light emitting diode (LED) driving device is used to drive an LED module. A conductive current flows through the LED module when the LED module is driven. The LED driving device includes a driving-controlling unit and a current-regulating unit. The driving-controlling unit is driven by a controllable current. The current-regulating unit is electrically connected to the LED module and the driving-controlling unit. The current-regulating unit divides the branch of the conductive current into two branches, and controls the current flowing through one of the branches to be proportional to the controllable current. Therefore, the current-regulating unit provides a stable current to the driving-controlling unit and prevents the driving-controlling unit from an overcurrent damage.

### BACKGROUND OF THE INVENTION

1. Field of the Invention

The present invention relates to a light emitting diode (LED) driving device, and more particularly to an LED driving device with a current-dividing mechanism.

2. Description of Prior Art

A light emitting diode (LED) is a current-driving element and has a characteristic of low-voltage unidirectional conduction. In addition, luminous flux variation of the LED depends on the current flowing through the LED. Hence, it is essential to provide a stable current source to the LED so as to maintain the uniform illumination of the LED.

At present, the driving controlling circuit, which is used to drive and control the LED strings, is generally a packaged integrated circuit (IC) and includes a controllable current. In order to maintain sufficient illumination of the LED string, the current flowing through the LED string must be increased when the number of the light emitting diodes increases.

The rated temperature of the LED driver IC would increase when the driving current of the LED string is larger than the maximum rated current so that the LED diver IC is disabled. It is desirable to achieve the objective of driving the LED string based on maintaining the illumination of the light emitting diodes and the driving current of the LED string so that the LED string can be normally controlled and driven by the LED driver IC.

### SUMMARY OF THE INVENTION

In order to solve the above-mentioned problems, a light emitting diode (LED) driving device is disclosed. The LED driving device is used to drive an LED module which flows through a conductive current. The LED driving device includes a driving-controlling unit and a current-regulating unit.

The driving-controlling unit is driven by a controllable current. The current-regulating unit is electrically connected to the LED module and the driving-controlling unit. The current-regulating unit divides the branch of the conductive current into two branches and controls the current flowing one of the branches to be proportional to the controllable current; whereby, the current-regulating unit provides a stable current to the driving-controlling unit.

The LED driving device adds a current-regulating unit between the LED module and the driving-controlling unit. The current-regulating unit divides the branch of the conductive current into two branches to control the current flowing through one of the branches to be proportional to the controllable current, thus driving the driving-controlling unit. Hence, the current-regulating unit can effectively prevent the driving-controlling unit from an overcurrent damage.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a circuit block diagram of a light emitting diode (LED) driving device according to the present invention;

FIG. 2 is a circuit diagram of the light emitting diode (LED) driving device to a first embodiment;

FIG. 3 is a circuit diagram of the light emitting diode (LED) driving device to a second embodiment.

### DETAILED DESCRIPTION OF THE INVENTION

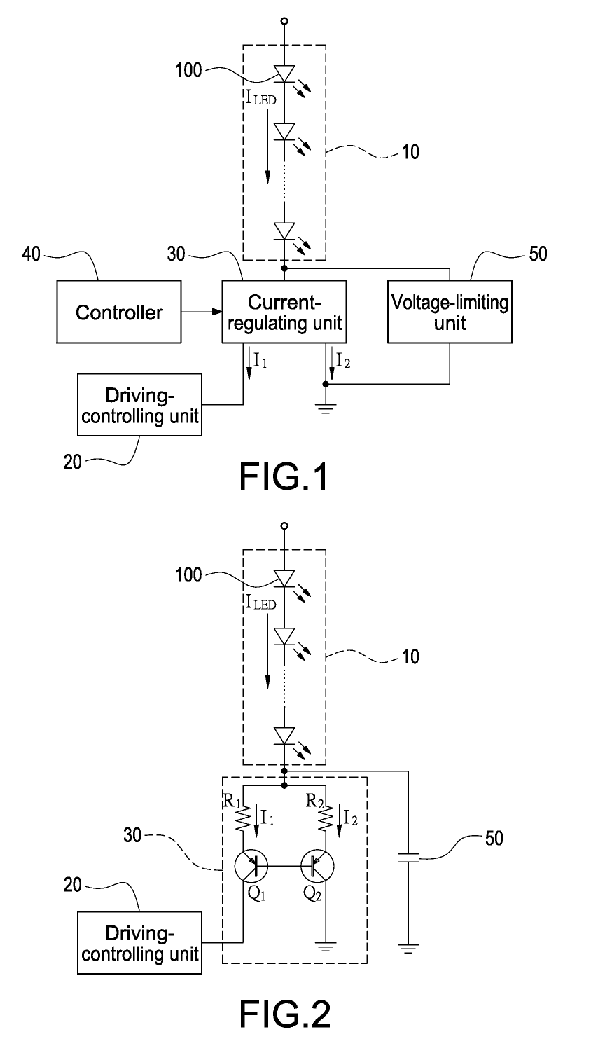

Referenced is made to the FIG. 1 which is a circuit block diagram of a light emitting diode (LED) driving device according to the present invention. The light emitting diode (LED) driving device is used to drive an LED module 10, and the LED driving device includes a driving-controlling unit 20 and a current-regulating unit 30.

The LED module 10 includes a plurality of light emitting diodes (LEDs) 100 electrically connected in series so that the same current flows through each of the light emitting diodes 100. That is, a conductive current ILED flows through the LED module 10.

The driving-controlling unit 20 is electrically connected to the LED module 10 for driving the light emitting diodes 100 to control the illumination of the light emitting diodes 100. In more particularly, the driving-controlling unit 20 is a packaged integrated circuit (IC), and which is driven by a controllable current IC.

The current-regulating unit 30 is electrically connected to the LED module 10 and the driving-controlling unit 20 to divide the branch of the conductive current ILED into two branches, namely, a first branch and a second branch, respectively. In this embodiment, the first branch is electrically connected to the driving-controlling unit 20 and the second branch is grounded. In more particularly, a first current I1 flows through the first branch and a second current I2 flows through the second branch.

In addition, the LED driving device further includes a controller 40 which is electrically connected to the current-regulating unit 30. The controller 40 is used to control the value of the first current I1, which flows to the driving-controlling unit 20, so that the first current I1 is proportional to the controllable current IC, namely, I1=n×IC, wherein the term n is a constant. Hence, the current-regulating unit 30 can prevent the driving-controlling unit 20 from an overcurrent damage. The second current I2 flows through the second branch, and the second current I2 equals that the conductive current ILED subtracts the first current I1, namely, I2=ILED−I1. The controller 40 provides a multiple relationship between the first current I1 and the second current I2, namely I1=N×I2, wherein the term N is a constant.

Moreover, the LED driving device further includes a voltage-limiting unit 50 which is electrically connected to the current-regulating unit 30 in parallel. The driving-controlling unit 20 is turned on or turned off when balancing internal current to detect an external signal. The variation of the forward voltage of the LED module depends on the number of the LEDs 100. However, each channel of the driving-controlling unit 20 causes unnecessary switching when detecting different forward voltages, thus resulting in a higher current ripple among the conductive current. The voltage-limiting unit 50 is provided to limit the voltage of the current-regulating unit 30 to relatively stabilize the voltage detected by the driving-controlling unit 20, thus overcoming the problem of the higher current ripple.

Reference is made to FIG. 2 which is a circuit diagram of the LED driving device according to a first embodiment of the present invention. In this embodiment, the current-regulating unit 30 is a current mirror consisted of two PNP bipolar junction transistors (BJTs), namely, a first transistor Q1 and a second transistor Q2. A base of the first transistor Q1 is electrically connected to a base of the second transistor Q2. A collector of the first transistor Q1 is electrically connected to the base of the first transistor Q1 and the driving-controlling unit 20, respectively. A collector of the second transistor Q2 is grounded. Moreover, an emitter of the first transistor Q1 is electrically connected to a first resistor R1 in series and an emitter of the second transistor Q2 is electrically connected to a second resistor R2 in series.

In a practical operation, the conductive current ILED of the LED module 10 flows into the current mirror, and the branch of the conductive current ILED is divided into a first branch and a second branch. In more particularly, a first current I1 flows through the first branch and a second current I2 flows through the second transistor Q2. The first transistor Q1 is the input side of the current mirror, thus, the conductive current ILED conducts a first current I1 (which is proportional to the controllable current Ic) to the first branch and provides the first current I1 to the driving-controlling unit 20. Because the current-regulating unit 30 is the current mirror, a second current I2 conducted to the second branch equals N times of I1, wherein N is a constant. Moreover, the conductive current ILED equals that the first current I1 adds the second current I2, namely, I1+I2=ILED.

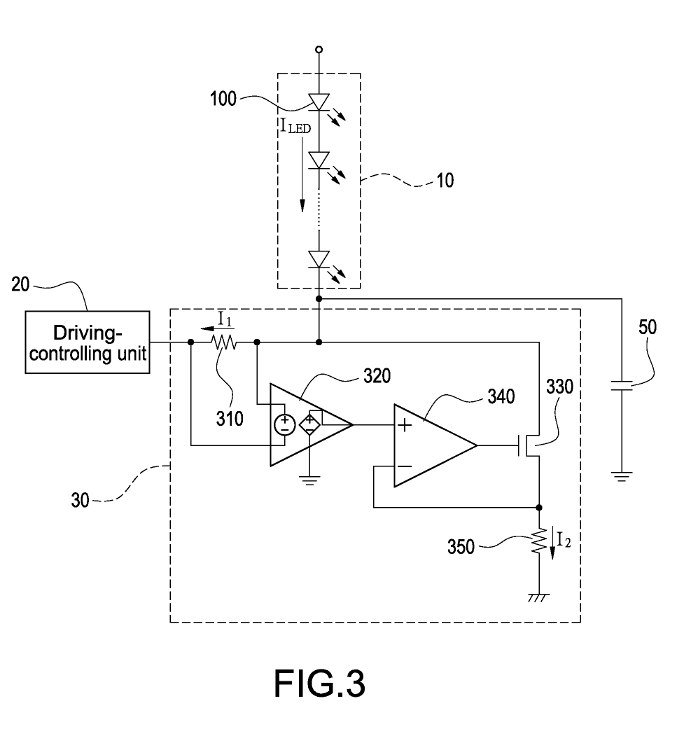

Reference is made to FIG. 3 which is a circuit diagram of the LED driving device to a second embodiment. In this embodiment, the current-regulating unit 30 includes a sampling resistor 310, a comparator 320, a switch element 330, an operational amplifier 340, and a setting resistor 350. The sampling resistor 310 is electrically connected between the LED module 10 and the driving-controlling unit 20. Two input ends of the comparator 320 are electrically connected across the sampling resistor 310 to obtain a sampling voltage. A drain (or a source) of the switch element 330 is electrically connected to the LED module 10 and a source (or a drain) of the switch element 330 is grounded through the setting resistor 350. An output end of the operational amplifier 340 is electrically connected to a gate of the switch element 330. A non-inverting input end of the operational amplifier 340 is electrically connected to an output end of the comparator 320. An inverting input end of the operational amplifier 340 is electrically connected to the setting resistor 350.

The branch of the conductive current ILED of the LED module 10 is divided into two branches, namely, a first branch and a second branch. A first current I1 in the first branch flows through the sampling resistor 310 to the driving-controlling unit 20 and the second current I2 in the second branch flows through the switch element 330.

A voltage drop across the sampling resistor 310 is produced when the first current I1 flows through the sampling resistor 310. The comparator 320 obtains the voltage drop as a sampling voltage and outputs the sampling voltage to the non-inverting input end of the operational amplifier 340. The second current I2 flows through the switch element 330 to the setting resistor 350, thus producing a setting voltage drop across the setting resistor 350 and inputting the setting voltage drop into the inverting input end of the operational amplifier 340. The operational amplifier 340 effectively regulates the first current I1 so that the first current I1 is proportional to the controllable current IC and the second current I2 equals that the conductive current ILED subtracts the first current I1.

In conclusion, the LED driving device according to the present invention provides a current-regulating unit electrically connected between the LED module and the driving-controlling unit so that the LED module can be driven by an applicable driving current to get a preferring luminous flux. The current-regulating unit effectively divides the branch of the conductive current into two branches so that the current flows through one of the branches is used for driving the driving-controlling unit and is proportional to the controllable current. Hence, the current-regulating unit can effectively prevent the driving-controlling unit from an overcurrent damage. Moreover, a voltage-limiting unit is provided to overcome the problem of the higher current ripple of the LED module.

Although the present invention has been described with reference to the foregoing preferred embodiments, it will be understood that the invention is not limited to the detail thereof. Various equivalent variations and modifications can still occur to those skilled in this art in view of the teachings of the present inventions. Thus, all such variations and equivalent modifications are also embraced within the scope of the invention as define in the appended claims.

What is claimed is:

1. A light emitting diode driving device for driving a light emitting diode (LED) module, the light emitting diode module flowing through a conductive current, the light emitting diode driving device comprising:
a driving-controlling unit driven by a controllable current; and
a current-regulating unit electrically connected to the light emitting diode module and the driving-controlling unit, the current-regulating unit dividing the branch of the conductive current into two branches and controlling the current flowing through one of the branches to be proportional to the controllable current;
whereby the current-regulating unit providing a stable current to the driving-controlling unit.

2. The light emitting diode driving device in claim 1, wherein the current-regulating unit comprises a first transistor and a second transistor; a base of the first transistor is electrically connected a collector of the first transistor, the base of the first transistor is electrically connected a base of the second transistor, the collector of the first transistor is electrically connected to the driving-controlling unit, and a collector of the second transistor is grounded.

3. The light emitting diode driving device in claim 2, further comprising two resistors electrically connected to an emitter of the first transistor and an emitter of the second transistor, respectively.

4. The light emitting diode driving device in claim 2, wherein the first transistor and the second transistor are both a bipolar junction transistor.

5. The light emitting diode driving device in claim 1, wherein the current-regulating unit comprises:
a sampling resistor electrically connected between the light emitting diode module and the driving-controlling unit;
a comparator having two input ends electrically connected across the sampling resistor;
a switching element electrically connected to the light emitting diode module;
a setting resistor electrically connected to the switching element; and
an operational amplifier having a non-inverting input end, an inverting input end and an output end, wherein the non-inverting input end is electrically connected to an output end of the comparator, the inverting input end is electrically connected to the setting resistor, and the output end is electrically connected to a gate of the switching element.

6. The light emitting diode driving device in claim 1, wherein the light emitting diode module includes a plurality of light emitting diodes, and the light emitting diodes are electrically connected in series.

7. The light emitting diode driving device in claim 1, further comprising a controller electrically connected to the current-regulating unit.

8. The light emitting diode driving device in claim 1, further comprising a voltage-limiting unit electrically connected to the current-regulating unit.
